(19) United States
(12) Patent Application Publication
(10) Pub. No.: US 2024/0065468 A1
(43) Pub. Date: Feb. 29, 2024

(54) BREWING SYSTEM AND METHOD FOR CONTROLLING BREWING BASED ON ORIGIN OF BREWING MATERIAL

(71) Applicant: COCREATE VENTURE TECHNOLOGY LLP, Bengaluru (IN)

(72) Inventors: Narasimha Suresh, Bengaluru (IN); Madhu Venkatesh Murthy, Bengaluru (IN); Akshay Komarla Badrinath, Bengaluru (IN); Kiriti Kapavari, Bengaluru (IN)

(21) Appl. No.: 18/456,747

(22) Filed: Aug. 28, 2023

(30) Foreign Application Priority Data
Aug. 29, 2022 (IN) 202241049331

(51) Int. Cl. A47J 31/00

(52) U.S. Cl. CPC A47J 31/002

(57) ABSTRACT

The present invention discloses a brewing system and method for controlling brewing based on origin of brewing material. The brewing method includes receiving a user selection of a brewing recipe from a list of brewing recipes, arranged in order of historical selection frequencies, for making the beverage along with a quantity of the beverage. The brewing method also includes selecting at least one brewing material based on the user-selected brewing recipe. Further, the brewing method includes determining quantity of the selected brewing material and determining respective values of parameters based on the selected brewing recipe and the selected brewing material. Thereafter, the brewing method includes controlling elements of the brewing device based on the determined quantity of the selected brewing material and the respective values of the parameters to make the beverage.

### BACKGROUND

### Technical Field

The present disclosure relates to the field of brewing machines, and in particular, relates to a brewing system and method for controlling brewing based on origin of brewing material.

### Description of the Related Art

A brewing machine is used for brewing a brewing material to make a beverage. The brewing material may, without any limitations, include coffee beans, tea leaves, corn, rice, barley, wheat, sugar, and/or syrups. Accordingly, the beverages may, without any limitation, include coffee, tea, and a glass of beer. During the brewing, there are many factors and/or parameters that affect the taste of the beverage. For example, volume, dispensation rate, flow path, water temperature, grind size of the brewing material, and steeping time. Therefore, such factors and/or parameters must be maintained during brewing for creating a high-quality beverage. Typically, the brewing machines are operated manually. Since not everyone is a field expert to understand the importance of such parameters/factors and even the field experts cannot control such parameters/factors accurately at every instance, usually the brewed beverages are inconsistent in taste, odor, and/or quality.

Further, the different brewing materials and brewing materials from different origins require different parameters/factors for a high-quality beverage. Additionally, different brewing recipes require different parameters/factors at various levels for making the beverage with an optimum taste of that recipe. For example, a coffee from Brazil has to be brewed differently than a coffee from Coorg for optimum taste, an Arabica coffee needs to be brewed differently from a Robusta for optimum taste, a Belgian beer requires different brewing from an Australian Beer, and so on. Therefore, the task of the operator of the brewing machine becomes further difficult because of the possession of knowledge of various parameters/factors of various recipes as well as accurately maintaining such parameters/factors for a high-quality beverage. However, automatic brewing machines also exist in the industry that overcome some of the above-mentioned problems like automatic handling of volume of the brewing material. For example, an automatic coffee machine that can make different types of coffees with different volumes of Coffee powder like Espresso, Cappuccino, and Latte. Additionally, some of such automatic brewing machines also have remote operation using Bluetooth.

However, such automatic brewing machines are limited to mere automatic control of the volume of a single type of brewing material and cannot handle automatic control of other parameters for different brewing recipes like temperature and steeping time. Accordingly, such automatic brewing machines are also limited to mere various beverages of a single type of brewing material and cannot handle different brewing materials from different areas or types because it requires the handling of a large number of more complex parameters. The conventional automatic brewing machines are limited to hot brews only and are incapable of preparing cold brews. Additionally, such automatic brewing machines fail to provide information on the origin of the brewing recipes to the user for a better selection of the brewing recipe.

Thus, there is a need for an improved brewing system and method for controlling brewing to make beverages to overcome the drawbacks of the conventional systems.

### BRIEF SUMMARY

One or more embodiments are directed to a brewing system and method for controlling brewing based on origin of brewing material. The system is installed in existing brewing machines to achieve controlled brewing. The brewing system is secured through one or more ways of authentication such as fingerprint scanner, face detection, retina scanner, or other biometrics to ensure that the only authorized users (such as subscribers, employees, members, and the like) are allowed to access the brewing system and/or limit accessibility for each user or types of users. The brewing system may be connected to a digital console or a mobile device through a short-range wireless system to provide information (such as the origin of the beverage or brewing recipe). Such connection also facilitates the user to wirelessly control the brewing system by providing inputs pertaining to brewing recipes and/or personalized parameters such as volume, temperature, and steeping time. The brewing system achieves a perfect brew with a high-quality beverage while providing users with the knowledge of the origin of the beverage.

An embodiment of the present disclosure discloses the brewing system for controlling brewing based on the origin of the brewing material to make a beverage. The beverage corresponds to a hot beverage (such as coffee) or a cold beverage (such as beer). The system includes a receiver module to receive a user selection of a brewing recipe from one or more brewing recipes for making the beverage along with a quantity of the beverage. The brewing recipe includes the required brewing material along with details of the one or more parameters for making the beverage with an original taste and the one or more brewing recipes are arranged in order of historical selection frequencies of the user, brewing device, or both.

In some embodiments, the brewing system includes a material selector module to select at least one brewing material from one or more brewing materials based on the user-selected brewing recipe. The one or more brewing materials include coffee beans, tea leaves, corn, rice, barley, wheat, sugar, syrups, or a combination thereof. In some embodiments, the brewing system includes a regulator module for regulating one or more ingredients of the beverage. The regulator module includes a quantity regulator module to determine quantity of the at least one selected brewing material. Further, the regulator module includes a parameter regulator module to determine the respective values of one or more parameters based on the selected brewing recipe and the at least one selected brewing material. The one or more parameters include temperature, pressure, volume, and/or steeping time.

In some embodiments, the brewing system includes a control module to control one or more elements of the brewing device based on the determined quantity of the at least one selected brewing material and the respective values of the one or more parameters to make the beverage. The one or more elements include a raw material inserter, a pressure pump, a heating coil, a refrigeration coil, a water dispenser, and/or a brewing material dispenser.

In some embodiments, the brewing system includes an authentication module to authenticate an authorized user to access the brewing device to modify the one or more parameters of the brewing device, wherein the authentication is associated with bio-metrics detection, passcode detection, and/or Radio-Frequency Identification (RFID) detection. In some embodiments, the brewing system includes an information module to fetch and render information about at least one brewing recipe of the one or more brewing recipes to the user based on selection by the user, historical data of the user, and/or historical data of the brewing device. In some embodiments, the brewing system either includes or is communicatively coupled to one or more sensors to sense and provide real-time data pertaining to the one or more parameters to the regulator module for controlled brewing by error identification and correction.

An embodiment of the present disclosure discloses the brewing method for controlling brewing based on the origin of the brewing material to make a beverage. The method includes the steps of receiving a user selection of a brewing recipe from one or more brewing recipes for making the beverage along with a quantity of the beverage. The one or more brewing recipes are arranged in order of historical selection frequencies of the user, brewing device, or both. The brewing method also includes the steps of selecting at least one brewing material from one or more brewing materials based on the user-selected brewing recipe. The brewing method further includes the steps of determining quantity of the at least one selected brewing material and determining respective values of one or more parameters based on the selected brewing recipe and the at least one selected brewing material. Thereafter, the brewing method includes the steps of controlling one or more elements of the brewing device based on the determined quantity of the at least one selected brewing material and the respective values of the one or more parameters to make the beverage.

In some embodiments, the brewing method also includes the steps of authenticating an authorized user to access the brewing device to modify the one or more parameters of the brewing device. The authentication is associated with bio-metrics detection, passcode detection, and/or Radio-Frequency Identification (RFID) detection. In some embodiments, the brewing method includes the steps of fetching and rendering information about at least one brewing recipe of the one or more brewing recipes to the user. Such fetching and rendering are based on selection by the user, historical data of the user, and/or historical data of the brewing device. In some embodiments, the brewing method includes sensing and providing real-time data pertaining to the one or more parameters to the regulator module for controlled brewing by error identification and correction.

The Features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the FIGURES, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates a block diagram of an environment of a brewing system for controlling brewing based on origin of brewing material to make a beverage, in accordance with various embodiments of the present disclosure.

FIG. 1B illustrates a block diagram of a brewing device having the brewing system for controlling brewing based on origin of brewing material to make a beverage, in accordance with various embodiments of the present disclosure.

FIG. 2 illustrates a block diagram of the brewing system for controlling brewing based on origin of brewing material to make a beverage, in accordance with various embodiments of the present disclosure.

FIG. 3 illustrates a process flow of an operation of the brewing system for controlling brewing based on origin of brewing material to make a beverage, in accordance with various embodiments of the present disclosure.

FIG. 4 illustrates a flowchart of brewing method for controlling brewing based on origin of brewing material to make a beverage, in accordance with an embodiment of the present disclosure.

FIG. 5 illustrates an exemplary computer system in which or with which embodiment of the present disclosure may be utilized.

Other features of embodiments of the present disclosure will be apparent from accompanying drawings and detailed description that follows.

### DETAILED DESCRIPTION

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form to avoid obscuring the concepts of the presently disclosed method and system

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and thus, are not intended to be limited to any particular named.

A brewing system and method for controlling brewing based on origin of brewing material to make a beverage is disclosed. The system is installed in existing brewing machines to achieve controlled brewing. The brewing system is secured through one or more ways of authentication such as fingerprint scanner, face detection, retina scanner, or other biometrics to ensure that the only authorized users (such as subscribers, employees, members, and the like) are allowed to access the brewing system and/or limit accessibility for each user or types of users. The brewing system may be connected to a digital console or a mobile device through a short-range wireless system to provide information (such as the origin of the beverage or brewing recipe). Such connection also facilitates the user to wirelessly control the brewing system by providing inputs pertaining to brewing recipes and/or personalized parameters such as volume, temperature, and steeping time. The brewing system achieves a perfect brew with a high-quality beverage while providing users with the knowledge of the origin of the beverage.

In some embodiment, the brewing system may receive a user selection of a brewing recipe from one or more brewing recipes for making the beverage along with a quantity of the beverage. Such one or more brewing recipes may be arranged in order of historical selection frequencies of the user, brewing device, or both. Further, the brewing system may select at least one brewing material from one or more brewing materials based on the user-selected brewing recipe. Upon selection of the brewing material, the brewing system may determine the quantity of the at least one selected brewing material and determine respective values of one or more parameters based on the selected brewing recipe and the at least one selected brewing material. Thereafter, the brewing system may control one or more elements of the brewing device based on the determined quantity of the at least one selected brewing material and the respective values of the one or more parameters.

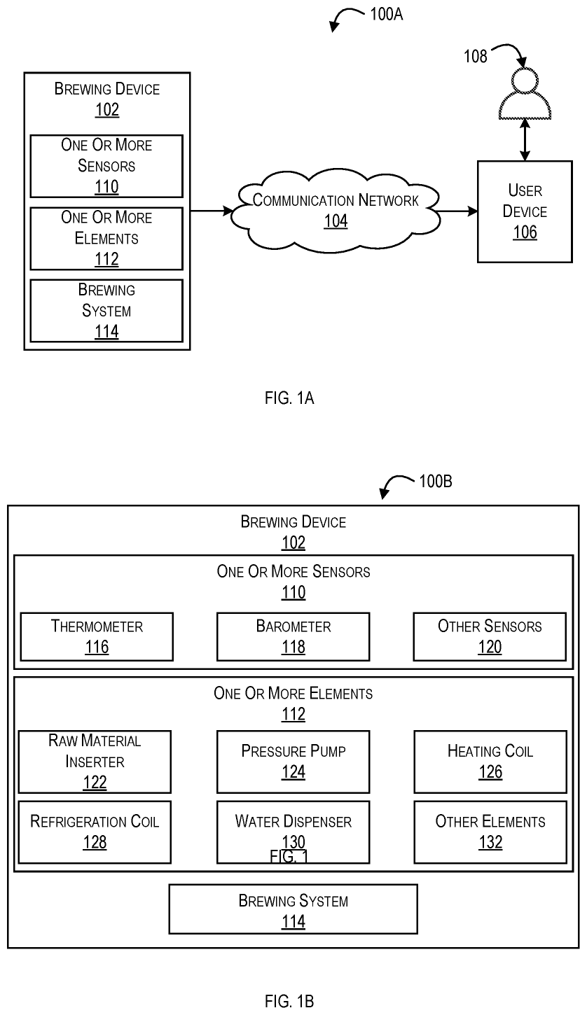

FIG. 1A illustrates a block diagram 100A of an environment of a brewing system 114 for controlling brewing based on origin of brewing material to make a beverage, in accordance with various embodiments of the present disclosure. FIG. 1B illustrates a block diagram 100B of a brewing device 102 having the brewing system 114 for controlling brewing based on the origin of brewing material to make the beverage, in accordance with various embodiments of the present disclosure. For the sake of brevity, FIGS. 1A and 1B have been explained together.

The environment may include the brewing system 114 installed in the brewing device 102, a communication network 104, a user device 106, and a user 108. The brewing device 102 may correspond to a device having one or more components for brewing a brewing material to make the beverage. Such brewing materials may, without any limitation, include coffee beans, tea leaves, corn, rice, barley, wheat, sugar, and/or syrups. Further, the beverage may correspond to either a hot beverage or a cold beverage made by the process of brewing and may, without any limitation, include coffee, tea, beer, or the like. Accordingly, the brewing device 102 may include, without any limitation, one or more sensors 110, one or more elements 112, and the brewing system 114. In some embodiment, as shown in FIG. 1B, the one or more sensors 110 may, without any limitation, include a thermometer 116, a barometer 118, and other sensors 120 like a load sensor, a water level sensor, or a timer. Similarly, the one or more elements 112 may, without any limitation, include a raw material inserter 122 (for dispensing the brewing material), a pressure pump 124 (for adjusting the pressure of the brewing), a heating coil 126 (for heating one or more components of the brewing recipe or the beverage), a refrigeration coil 128 (for cooling one or more components of the brewing recipe or the beverage), a water dispenser 130 (for dispensing water for brewing), and other elements 132 like a connection module. It may be understood that the connection module may correspond to any of the existing wireless modules (e.g., Bluetooth module, Infrared module, ZigBee module, or the like) for connecting the brewing device 102 with the user device 106 via the communication network 104. Accordingly, the communication network 102 may include, without limitation, a direct interconnection, a Local Area Network (LAN), a Wide Area Network (WAN), a wireless network (e.g., using Wireless Application Protocol), the Internet, and the like.

In an embodiment, the user device 106 may facilitate the user 108 to access the brewing system 114 for controlling the brewing to make the beverage. The user device 106 may, without any limitation, include a smartphone, a Personal Assistant Device (PDA), a PC, a tablet, a laptop, a smartwatch, and so on. In general, the user device 106 may be any equipment that allows the user 108 to view details regarding the brewing of the beverage and controlling the brewing. Such details may, without any limitation, include the origin of raw material used for brewing, one or more brewing recipes, and/or parameters like temperature, pressure, steeping time, and so on for brewing the beverage. In an embodiment, the user device 106 may include an interface through which the user may view details regarding the brewing of the beverage and control the brewing. The interface may include, but is not limited to, a display screen, a microphone, a speaker, and so on. The brewing system 114 may facilitate controlling the brewing process by controlling one or more components of the brewing device 102. In an embodiment, the brewing system 114 may be implemented as a detachable processing core which may be retrofitted in existing brewing devices by simply replacing the existing processing core of the brewing device. The brewing system 114 has been discussed in detail in the following paragraphs.

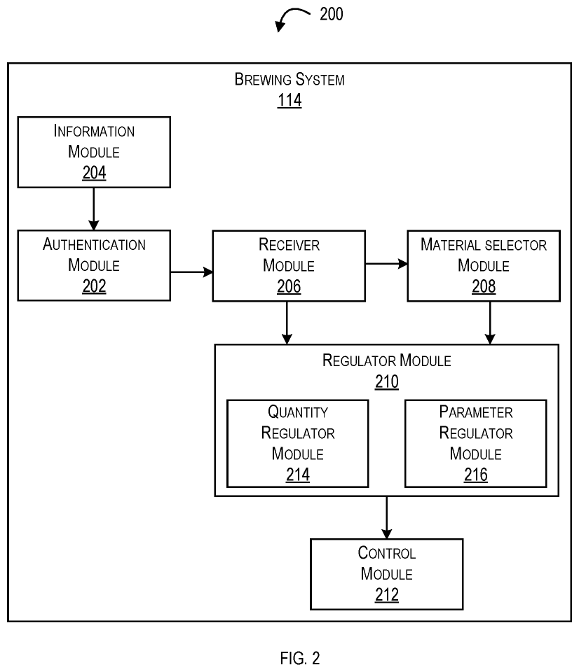

FIG. 2 illustrates a block diagram 200 of the brewing system 114 for controlling brewing based on origin of brewing material to make a beverage, in accordance with various embodiments of the present disclosure.

The brewing system 114 may include one or more processors, an Input/Output (I/O) interface, one or more modules, and a memory. In some non-limiting embodiments or aspects, the memory may be communicatively coupled to one or more processors. The memory stores instructions, executable by the one or more processors, which on execution, may cause the brewing system 114 to control the brewing. In some non-limiting embodiments or aspects, the memory may include data that may, without any limitation, include one or more brewing recipes, associated parameters, and instructions. The one or more modules may perform the steps of the present disclosure using the data to control the brewing by controlling the one or more elements 112 of the brewing device 102. In some non-limiting embodiments or aspects, each of the one or more modules may be a hardware unit, which may be outside the memory and coupled with the brewing system 114. In some non-limiting embodiments or aspects, the brewing system 114 may be implemented in a variety of computing systems, such as a laptop computer, a desktop computer, a Personal Computer (PC), a notebook, a smartphone, a tablet, e-book readers, a server, a network server, a cloud server, and the like. In a non-limiting embodiment, each of the one or more modules may be implemented with a cloud-based server, communicatively coupled with the brewing system 114.

In some embodiment, as shown in FIG. 2, the one or more modules of the brewing system 114 may include an authentication module 202, an information module 204, a receiver module 206, a material selector module 208, a regulator module 210, and a control module 212. The authentication module 202, the information module 204, the receiver module 206, the material selector module 208, the regulator module 210, and the control module 212 may be communicatively coupled to the memory and the processor of the brewing system 114.

The processor may control the operations of the authentication module 202, the information module 204, the receiver module 206, the material selector module 208, the regulator module 210, and the control module 212. In an embodiment of the present disclosure, the processor and the memory may form a part of a chipset installed in the brewing system 112. In another embodiment of the present disclosure, the memory may be implemented as a static memory or a dynamic memory. In an example, the memory may be internal to the brewing system 112, such as an onside-based storage. In another example, the memory may be external to the brewing system 112, such as cloud-based storage. Further, the processor may be implemented as one or more microprocessors, microcomputers, digital signal processors, central processing units, state machines, logic circuitries, and/or any devices that manipulate signals based on operational instructions.

In some embodiments, the authentication module 202 may allow only authorized users to access the brewing device 102. The authentication module 202 may utilize one or more ways of authentication such as bio-metrics detection (like a fingerprint scanner, face detection, and retina scanner), passcode detection, and/or Radio-Frequency Identification (RFID) detection to ensure that only authorized users (such as subscribers, employees, members, and the like) access the brewing system 114. In other embodiments, the authentication module 202 may be utilized to limit accessibility for each user or type of user. For example, the authentication module 202 may allow only an authorized user (such as an operator or owner of the brewing device 102) to modify the one or more parameters of the brewing device 102.

In some embodiments, the information module 204 may render information about one or more brewing recipes for user selection. In operation, when the user 108 is authenticated to use the brewing device 102 by the authentication module 202, information module 204 displays one or more brewing recipes to the user 108 arranged in order of historical selection frequencies of the user 108, the brewing device 102, or both. Further, the information module 204 may fetch, from the memory, and render the one or more brewing recipes with associated information or may facilitate the user 108 to select at least one brewing recipe to render the associated information. In an embodiment, the rendered information may correspond to the origin of the brewing recipe, beverage, the associated brewing material, and required parameters.

In some embodiment, the receiver module 206 may receive a user selection of a brewing recipe from the one or more brewing recipes for making the beverage. It may be noted that the user selection may be inclusive of a quantity of the beverage and the brewing recipe may, without any limitation, include required brewing material along with details of the one or more parameters for making the beverage with original taste i.e., a high-quality beverage. As discussed in previous paragraphs, the one or more parameters may correspond to the one or more parameters including temperature, pressure, volume, and steeping time at one or more stages during the brewing for making the beverage.

In some embodiments, the material selector module 208 may select at least one brewing material from one or more brewing materials based on the user-selected brewing recipe. For example, if the user selected Vietnamese Coffee, then the material selector module 208 may identify that a Liberica type of Coffee may be required for making it.

In some embodiments, after the brewing material is selected by the material selector module 208, the regulator module 210 may then identify the quantities of various materials required along with one or more stages and associated parameters for making the beverage through the selected brewing recipe. In order to perform such identification, the regulator module 210 may include a quantity regulator module 214 and a parameters regulator module 216. The quantity regulator module 214 may determine a quantity of the at least one selected brewing material and the received quantity by the user 108. For example, if 10 gm of Liberica coffee is required for making 100 ml of Vietnamese Coffee and the user' required quantity is 250 ml, then the quantity regulator module 214 may determine that 25 gm of Libera coffee, 200 ml of Milk, and 50 ml of water are required for brewing. Further, the parameter regulator module 216 may determine respective values of one or more parameters at one or more stages based on the selected brewing recipe and the at least one selected brewing material. For example, the parameter regulator module 214 may determine that water must be heated at a temperature of 65 degrees for brewing, the rate of flow of the heated water must be at a speed that makes the steeping time 5 minutes, milk must be heated at a temperature of 100 degrees before mixing with brewed coffee, and the prepared beverage (i.e., Vietnamese Coffee) must be cooled to a temperature of 3 degrees before serving. In an embodiment, the regulator module 210 may also receive real-time data pertaining to the one or more parameters from the one or more sensors 110 for improving controlling of the brewing process by real-time error identification and correction.

In some embodiments, the control module 212 may control one or more elements 112 of the brewing device 102 based on the determined quantity of the at least one selected brewing material and the respective values of the one or more parameters to make the beverage. Such controlling may be time-based and may be performed by controlling the supplied voltage and/or current to such one or more elements 114. For example, the control module 212 may control the raw material inserter 122 to dispense 25 gm of Liberica coffee and 200 ml of Milk, control the water dispenser 130 to dispense 50 ml of water, control the heating coil to heat the water to 65 degrees and milk at 100 degrees, control the pressure pump 124 to control the rate of flow of the heated water a speed that makes the steeping time 5 minutes, and control the refrigeration coil 128 to cool the prepared beverage (i.e. Vietnamese Coffee) a temperature of 3 degrees before serving.

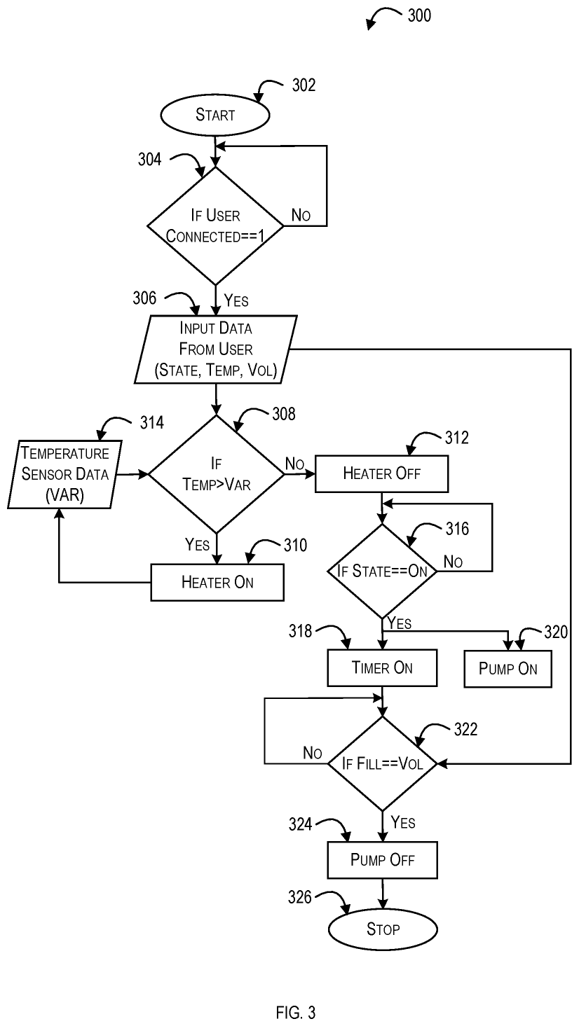

FIG. 3 illustrates a process flow 300 of an operation of the brewing system 114 for controlling brewing based on the origin of brewing material to make a beverage, in accordance with various embodiments of the present disclosure. The operation may start at step 302.

At first, the brewing system 114 checks if the user 108 is connected to the brewing device 102, as shown by the box 304. Further, if the user 108 is connected, then the brewing system 114 may receive input data from the user, as shown by the box 306. The input data may be associated with a selection of the beverage, a brewing recipe, and/or one or more manual parameters such as the state of the heater, temperature, and volume. Upon receiving the input data, the brewing system 114 may turn ON the heater for hearing the brewing material, as shown by the box 310. Further, the brewing system 114 may continuously receive temperature data during the brewing process from the thermometer, as shown by the box 314, and check when the received temperature data crosses the required temperature, as shown by the box 308. When the received temperature data crosses the required temperature, the brewing system 114 turns OFF the heater, as shown by the box 312. As a result, the brewing process may be completed with precision to make a high-quality beverage. For serving the made beverage, the brewing system 114 may check if the state of the heater state of the serving pump is ON, as shown by the box 316. When the heater state of the serving pump is ON, then the brewing system 114 may turn ON the timer while serving the made beverage, as shown by the box 318. Thereafter, the brewing system 114 may check if the filled amount, determined based on the time on the timer, is equal to the received volume in input data, as shown by the box 322. Thereafter, when the filled amount is equal to the received volume, then the brewing system 114 may turn the serving pump OFF, as shown by the box 324 to end the operation of the brewing device 102 at step 326.

Thus, the brewing system 114 implements an algorithm/mechanism to collect feedback using sensors and utilizes such data to correctly dispense or perform brewing activity. The feedback includes checking if the current temperature is as per desired temperature. Further, the feedback includes checking if the state of the heater is ON or OFF and if the timer is set to desired duration. The feedback also includes monitoring the volume. Based on the feedback, necessary actions are taken to control the temperature sensor, the heater, and the pump. The brewing system 114 also tracks the status and condition of brew and accordingly displays the status and the condition on the user device 106.

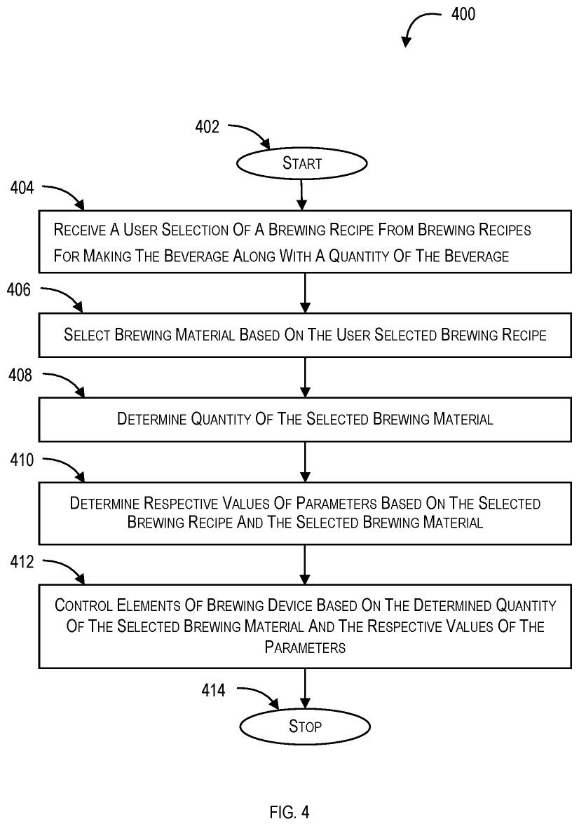

FIG. 4 illustrates a flowchart 400 of a brewing method for controlling brewing based on origin of brewing material to make a beverage, in accordance with an embodiment of the present disclosure. The method starts at step 402.

At first, at step 404, a user selection of a brewing recipe from one or more brewing recipes may be received for making the beverage along with a quantity of the beverage. The one or more brewing recipes may be arranged in order of historical selection frequencies of the user, brewing device, or both. The brewing recipe may include required brewing material along with details of the one or more parameters for making the beverage with the original taste.

Further, at step 406, at least one brewing material from one or more brewing materials may be selected based on the user-selected brewing recipe. The one or more brewing materials may, without any limitation, include coffee beans, tea leaves, corn, rice, barley, wheat, sugars, and/or syrups. Further, at step 408, quantity of the at least one selected brewing material may be determined.

After that, at step 410, respective values of one or more parameters based on the selected brewing recipe and the at least one selected brewing material may be determined. The one or more parameters may, without any limitation, include temperature, pressure, volume, and/or steeping time.

Thereafter, at step 412, one or more elements of the brewing device may be controlled based on the determined quantity of the at least one selected brewing material and the respective values of the one or more parameters. The one or more elements may, without any limitation, include a raw material inserter, a pressure pump, a heating coil, a refrigeration coil, a water dispenser, and/or a brewing material dispenser.

In some embodiments, the brewing method may include the steps of authenticating an authorized user to access the brewing device to modify the one or more parameters of the brewing device. The authentication may, without any limitation, be associated with bio-metrics detection, passcode detection, and/or Radio-Frequency Identification (RFID) detection. In some embodiments, the brewing method may also include fetching and rendering information about at least one brewing recipe of the one or more brewing recipes to the user based on selection by the user, historical data of the user, and/or historical data of the brewing device. In some embodiments, the brewing method may also include sensing and providing real-time data pertaining to the one or more parameters to the regulator module for controlled brewing by error identification and correction. The method ends at step 414.

A brewing system and method (hereinafter called brewing mechanism) for controlling brewing based on the origin of brewing material to make a beverage are disclosed. The brewing mechanism provides information on the origin of the beverages, brewing recipes, and/or the brewing material. The brewing mechanism also provides options through the application on the user's device to select the user's option and check the current status. The brewing mechanism may be implemented with any brewing system which is capable of brewing any beverage including, but not limited to, coffee, tea, herbs concentrated water, and other hot or cold beverages.

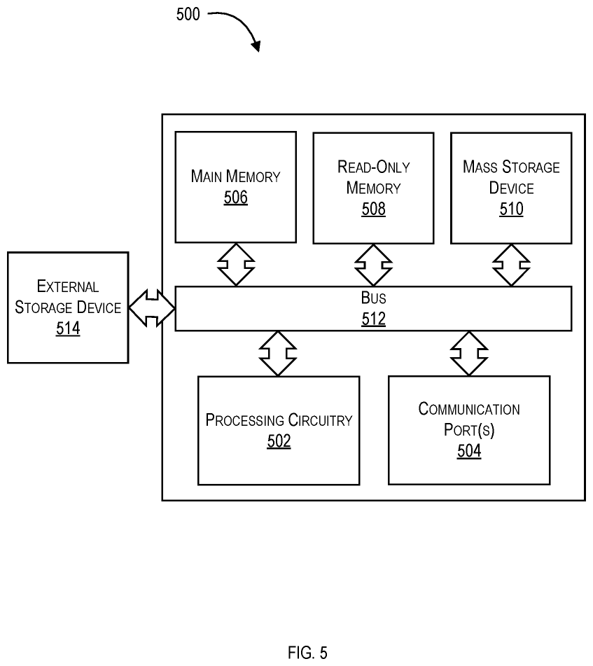

FIG. 5 illustrates an exemplary computer system in which or with which embodiment of the present disclosure may be utilized. As shown in FIG. 5, a computer system 500 includes an external storage device 514, a bus 512, a main memory 506, a read-only memory 508, a mass storage device 510, a communication port 504, and a processor 502.

Those skilled in the art will appreciate that computer system 500 may include more than one processor 502 and communication ports 504. Examples of processor 502 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 502 may include various modules associated with embodiments of the present disclosure.

Communication port 504 can be any of an RS-232 port for use with a modem-based dialup connection, a 10/100 Ethernet port, a Gigabit or 10 Gigabit port using copper or fiber, a serial port, a parallel port, or other existing or future ports. Communication port 504 may be chosen depending on a network, such as a Local Area Network (LAN), Wide Area Network (WAN), or any network to which the computer system 500 connects.

Memory 506 can be Random Access Memory (RAM), or any other dynamic storage device commonly known in the art. Read-Only Memory 508 can be any static storage device(s) e.g., but not limited to, a Programmable Read-Only Memory (PROM) chips for storing static information e.g., start-up or BIOS instructions for processor 502.

Mass storage 510 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 512 communicatively couples processor(s) 502 with the other memory, storage, and communication blocks. Bus 512 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 502 to a software system.

Optionally, operator and administrative interfaces, e.g., a display, keyboard, and a cursor control device, may also be coupled to bus 512 to support direct operator interaction with the computer system. Other operator and administrative interfaces can be provided through network connections connected through communication port 504. An external storage device 514 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

We claim:

1. A brewing system for controlling brewing based on origin of brewing material to make a beverage, the brewing system comprising:
a receiver module to receive a user selection of a brewing recipe from one or more brewing recipes for making the beverage along with a quantity of the beverage, wherein the one or more brewing recipes are arranged in order of historical selection frequencies of at least one of: user and brewing device;
a material selector module to select at least one brewing material from one or more brewing materials based on the user-selected brewing recipe;
a regulator module having:
a quantity regulator module to determine quantity of the at least one selected brewing material;
a parameter regulator module to determine respective values of one or more parameters based on the selected brewing recipe and the at least one selected brewing material; and
a control module to control one or more elements of the brewing device based on the determined quantity of the at least one selected brewing material and the respective values of the one or more parameters to make the beverage.

2. The brewing system of claim 1, further comprising an authentication module to authenticate an authorized user to access the brewing device to modify the one or more parameters of the brewing device, wherein the authentication is associated with at least one of: bio-metrics detection, passcode detection, and Radio-Frequency Identification (RFID) detection.

3. The brewing system of claim 1, wherein the brewing recipe includes at least one of: required brewing materials along with details of the one or more parameters for making the beverage with original taste.

4. The brewing system of claim 3, further comprising an information module to fetch and render information about at least one brewing recipe of the one or more brewing recipes to the user based at least on one of: selection by the user, historical data of the user, and historical data of the brewing device.

5. The brewing system of claim 1, wherein the one or more parameters includes at least one of: temperature, pressure, volume, and steeping time.

6. The brewing system of claim 1, wherein the one or more elements include at least one of: a raw material inserter, a pressure pump, a heating coil, a refrigeration coil, a water dispenser, and a brewing material dispenser.

7. The brewing system of claim 1, further comprising one or more sensors to sense and provide real-time data pertaining to the one or more parameters to the regulator module for controlled brewing by error identification and correction.

8. The brewing system of claim 1, wherein the beverage corresponds to at least one of: a hot beverage and a cold beverage.

9. The brewing system of claim 1, wherein the one or more brewing materials include at least one of: coffee beans, tea leaves, corn, rice, barley, wheat, sugar, and syrups.

10. A brewing method for controlling brewing based on origin of brewing material to make a beverage, the brewing method comprising:
receiving a user selection of a brewing recipe from one or more brewing recipes for making the beverage along with a quantity of the beverage, wherein the one or more brewing recipes are arranged in order of historical selection frequencies of at least one of: user and brewing device;
selecting at least one brewing material from one or more brewing materials based on the user-selected brewing recipe;
determining quantity of the at least one selected brewing material;
determining respective values of one or more parameters based on the selected brewing recipe and the at least one selected brewing material; and
controlling one or more elements of the brewing device based on the determined quantity of the at least one selected brewing material and the respective values of the one or more parameters to make the beverage.

11. The brewing method of claim 10, further comprising authenticating an authorized user to access the brewing device to modify the one or more parameters of the brewing device, wherein the authentication is associated with at least one of: bio-metrics detection, passcode detection, and Radio-Frequency Identification (RFID) detection.

12. The brewing method of claim 10, wherein the brewing recipe includes at least one of: required brewing materials along with details of the one or more parameters for making the beverage with original taste.

13. The brewing method of claim 12, further comprising fetching and rendering information about at least one brewing recipe of the one or more brewing recipes to the user based at least on one of: selection by the user, historical data of the user, and historical data of the brewing device.

14. The brewing method of claim 10, wherein the one or more parameters includes at least one of: temperature, pressure, volume, and steeping time.

15. The brewing method of claim 10, wherein the one or more elements include at least one of: a raw material inserter, a pressure pump, a heating coil, a refrigeration coil, a water dispenser, and a brewing material dispenser.

16. The brewing method of claim 10, further comprising sensing and providing real-time data pertaining to the one or more parameters to the regulator module for controlled brewing by error identification and correction.

17. The brewing method of claim 10, wherein the beverage corresponds to at least one of: a hot beverage and a cold beverage.

18. The brewing method of claim 10, wherein the one or more brewing materials include at least one of: coffee beans, tea leaves, corn, rice, barley, wheat, sugars, and syrups.
